(19) United States
(12) Patent Application Publication
(10) Pub. No.: US 2026/0008627 A1
(43) Pub. Date: Jan. 8, 2026

(54) TRANSFER SYSTEM

(71) Applicant: Mitsubishi Electric Corporation, Tokyo (JP)

(72) Inventors: Ryoya FUJIWARA, Tokyo (JP); Tatsuya KAWASE, Tokyo (JP); Yuji IGARASHI, Tokyo (JP)

(73) Assignee: Mitsubishi Electric Corporation, Tokyo (JP)

(21) Appl. No.: 19/123,403

(22) PCT Filed: Mar. 1, 2023
(86) PCT No.: PCT/JP2023/007642

§ 371 Date: Apr. 23, 2025

(51) Int. Cl. B65G 43/08; B65G 43/10

(52) U.S. Cl. CPC B65G 43/08; B65G 43/10

(57) ABSTRACT

A transfer system includes a plurality of transferring bodies, a transfer path on which the transferring bodies moves, and a controller that assigns identification information to each of the transferring bodies to manage the transferring bodies and controls each of the transferring bodies. On the transfer path, a reference point is set as a reference of position in a forward direction. The controller assigns, to a first transferring body that is one of the transferring bodies and is closest to the reference point in the forward direction, and assigns, to each of second transferring bodies that are the transferring bodies other than the first transferring body, second identification information as the identification information in sequence from the first identification information in an order of arrangement of the second transferring bodies in the forward direction or a backward direction.

### FIELD

The present disclosure relates to a transfer system that transfers an object.

### BACKGROUND

A production line in which factory automation is introduced such as a production line for assembling an industrial product or a production line for packaging a food product generally uses a transfer system that transfers a workpiece. In the transfer system, equipment for each of a plurality of processes is constructed on a path, and each of a plurality of carriers moving on the path is individually controlled, so that effects such as reduction in the area required for installation of the equipment, reduction in takt time, and greater flexibility in equipment design are expected. One mode of the transfer system is a so-called moving magnet linear motor with a magnet and coils, the magnet being disposed on the carrier as a mover, the coils being disposed on a stator forming a transfer path.

The transfer system equipped with an individual carrier identification function that allows a user of the transfer system to identify each of the plurality of the carriers can specify the carrier and give a unique operation or a unique role to the carrier. In this case, a highly functional and highly flexible production line can be constructed.

Patent Literature 1 discloses a transfer system in which one specific transferring body among a plurality of transferring bodies is detected by a detection unit, and with respect to the specific transferring body detected as reference, the plurality of the transferring bodies is each assigned identification information. The specific transferring body includes a protrusion that is absent in the transferring bodies other than the specific transferring body among the plurality of the transferring bodies. When the protrusion is detected, the specific transferring body is identified. Alternatively, a magnet is attached to the specific transferring body, and the specific transferring body is identified on the basis of a result of detecting the magnitude of a magnetic field. In this case, among the plurality of the transferring bodies, each of the transferring bodies other than the specific transferring body does not include a magnet similar to the magnet attached to the specific transferring body.

### CITATION LIST

### Patent Literature

Patent Literature 1: Japanese Patent Application Laid-open No. 2021-160842

### SUMMARY OF INVENTION

### Problem to be Solved by the Invention

The transfer system disclosed in Patent Literature 1 needs to separately prepare the transferring body, as the specific transferring body being one of the plurality of the transferring bodies, that is provided with the protrusion or magnet being a structure as a characteristic for identification, and the transferring body that is not provided with such a structure. Moreover, the transfer system disclosed in Patent Literature 1 needs to install the detection unit that detects the structure. As just described, in order to distinguish the transferring bodies, a plurality of types of the transferring bodies needs to be prepared with the provision of the structure, and thus the transfer system disclosed in Patent Literature 1 has had a problem that the configuration of the system becomes complicated and that the manufacturing cost is increased.

The present disclosure has been made in view of the above, and an object thereof is to provide a transfer system capable of identifying each of a plurality of transferring bodies with a simple configuration.

### Means to Solve the Problem

In order to solve the above problem and achieve the object, a transfer system according to the present disclosure includes a plurality of transferring bodies, a transfer path on which the plurality of the transferring bodies moves, and a controller that assigns identification information to each of the plurality of the transferring bodies to manage the plurality of the transferring bodies and controls each of the plurality of the transferring bodies. On the transfer path, a reference point is set as a reference of position in a forward direction that is one direction in which each of the plurality of the transferring bodies is moved. The controller assigns, to a first transferring body that is one of the plurality of the transferring bodies and is closest to the reference point in the forward direction, first identification information as a baseline of the identification information and assigns, to each second transferring body that is the transferring body other than the first transferring body among the plurality of the transferring bodies, second identification information that is the identification information in sequence from the first identification information in an order of arrangement of the second transferring body in the forward direction or a backward direction opposite to the forward direction.

### Effects of the Invention

The transfer system according to the present disclosure has an effect that each of the plurality of the transferring bodies can be identified with a simple configuration.

### BRIEF DESCRIPTION OF DRAWINGS

FIG. 1 is a diagram illustrating an exemplary configuration of a transfer system according to a first embodiment.

FIG. 2 is a diagram illustrating an example of a guide rail and a position detection unit included in the transfer system according to the first embodiment.

FIG. 3 is a diagram illustrating an exemplary configuration of a transfer system according to a second embodiment.

FIG. 4 is a diagram illustrating an exemplary configuration of a transfer system according to a third embodiment.

FIG. 5 is a diagram illustrating an exemplary configuration of a transfer system according to a fourth embodiment.

FIG. 6 is a diagram illustrating an exemplary configuration of a transfer system according to a fifth embodiment.

FIG. 7 is a diagram illustrating an exemplary configuration of a learning device included in the transfer system according to the fifth embodiment.

FIG. 8 is a diagram for explaining data preprocessing in a preprocessing unit included in the learning device according to the fifth embodiment.

FIG. 9 is a diagram illustrating an exemplary configuration of a neural network used for learning in the learning device according to the fifth embodiment.

FIG. 10 is a flowchart illustrating a procedure of learning processing by the learning device according to the fifth embodiment.

FIG. 11 is a diagram illustrating an exemplary configuration of a life estimation device included in the transfer system according to the fifth embodiment.

FIG. 12 is a flowchart illustrating a procedure of inference processing by the life estimation device according to the fifth embodiment.

FIG. 13 is a diagram illustrating an exemplary configuration of a control circuit according to the first to fifth embodiments.

FIG. 14 is a diagram illustrating an exemplary configuration of a hardware circuit that is dedicated according to the first to fifth embodiments.

### DESCRIPTION OF EMBODIMENTS

Hereinafter, a transfer system according to embodiments will be described in detail with reference to the drawings.

### First Embodiment

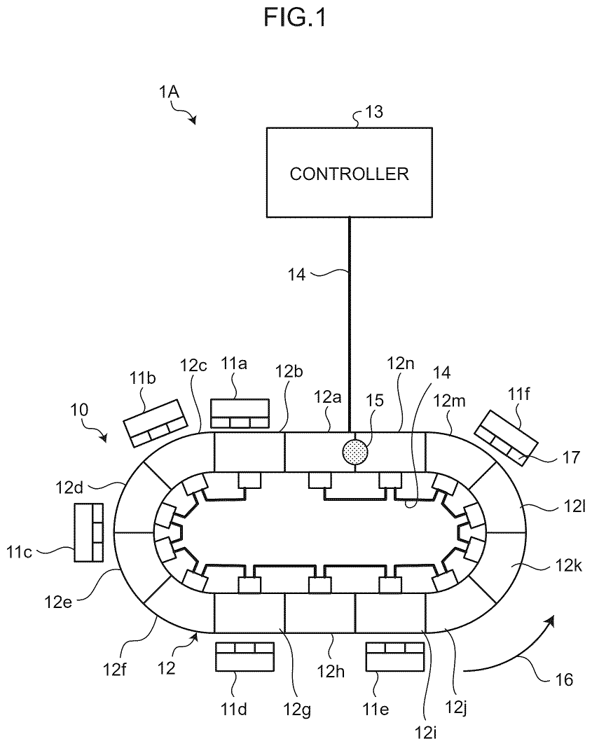

FIG. 1 is a diagram illustrating an exemplary configuration of a transfer system 1A according to a first embodiment. The transfer system 1A is a system used for transferring an object. In the first embodiment, the transfer system 1A transfers the object by moving a transferring body carrying the object.

The transfer system 1A includes a plurality of carriers 11a to 11f, a transfer path 10 that is a path on which the plurality of the carriers 11a to 11f moves, and a controller 13. The plurality of the carriers 11a to 11f is each the transferring body. In the following description, a carrier 11 refers to each of the carriers 11a to 11f without distinction thereamong.

The transfer path 10 includes a plurality of transfer path units 12a to 12n. The plurality of the transfer path units 12a to 12n is coupled to each other to form the single transfer path 10. The plurality of the transfer path units 12a to 12n moves the carriers 11a to 11f by giving thrust to the carriers 11a to 11f. In the following description, a transfer path unit 12 refers to each of the transfer path units 12a to 12n without distinction thereamong.

The transfer path 10 illustrated in FIG. 1 is an annular path. That is, the transfer path 10 illustrated in FIG. 1 is a closed path. The transfer path 10 of the transfer system 1A may be an open path. That is, the transfer path 10 of the transfer system 1A may be a path with a start point and an end point that are located away from each other.

The transfer path 10 illustrated in FIG. 1 is an oval path including linear paths and curved paths. The transfer path units 12a, 12b, 12g, 12h, 12i, and 12n are each the transfer path unit 12 that is linear and forms the linear path. The transfer path units 12c, 12d, 12e, 12f, 12j, 12k, 12l, and 12m are each the transfer path unit 12 that is curved and forms the curved path, and changes a direction of travel of the transferring body. The transfer path 10 may include only the transfer path unit 12 forming the curved path without including the transfer path unit 12 forming the linear path. The transfer path 10 with the start point and the end point that are located away from each other may include only the transfer path unit 12 forming the linear path. The transfer path 10 may have any overall shape.

The transfer system 1A according to the first embodiment includes a moving magnet linear motor. The carriers 11 each include a permanent magnet 17 constituting a mover. The transfer path units 12 each include a plurality of coils and a plurality of inverters. The inverter includes a switching element and supplies power, which has been converted by switching of the switching element, to the coil. The coil, when energized, interacts with a magnetic field generated by the permanent magnet 17 to generate thrust for moving the transferring body. The coils and the inverters are not illustrated.

The controller 13 is connected to the transfer path units 12 via a data communication line 14. The data communication line 14 includes a line connecting the controller 13 and the transfer path unit 12a, which is one of the plurality of the transfer path units 12, and lines connecting the transfer path units 12 adjacent to each other. Note that the transfer system 1A may include a plurality of the data communication lines 14, and the transfer path units 12 and the controller 13 may be directly connected by the data communication lines 14.

The controller 13 outputs a drive command to each of the transfer path units 12 via the data communication line 14. The drive command includes a command value of the current flowing through each of the coils in the transfer path unit 12. Each of the transfer path units 12 controls the current flowing through each of the coils in accordance with the command value included in a coil drive command. The controller 13 outputs the drive command to each of the transfer path units 12, thereby individually controlling each of the plurality of the carriers 11.

The direction of travel of the carriers 11 is a clockwise direction in FIG. 1 or a counterclockwise direction in FIG. 1. The counterclockwise direction in

FIG. 1 is defined as a forward direction, and the clockwise direction in FIG. 1 is defined as a backward direction. An arrow 16 illustrated in FIG. 1 indicates the forward direction. The controller 13 can individually control each of the carriers 11 to move in the forward direction and to move in the backward direction. Moreover, the controller 13 can individually control each of the carriers 11 regarding the position at which the carrier 11 is stopped, the speed of the carrier 11, or the like. Note that, here, the counterclockwise direction in FIG. 1 is defined as the forward direction, but the clockwise direction in FIG. 1 may be defined as the forward direction. Any direction may be defined as the forward direction.

In the example illustrated in FIG. 1, the transfer system 1A includes six of the carriers 11 and 14 of the transfer path units 12. The transfer system 1A may include any number of the carriers 11. The transfer system 1A need only include a plurality of the carriers 11. Also, the transfer path 10 may be formed by any number of the transfer path units 12.

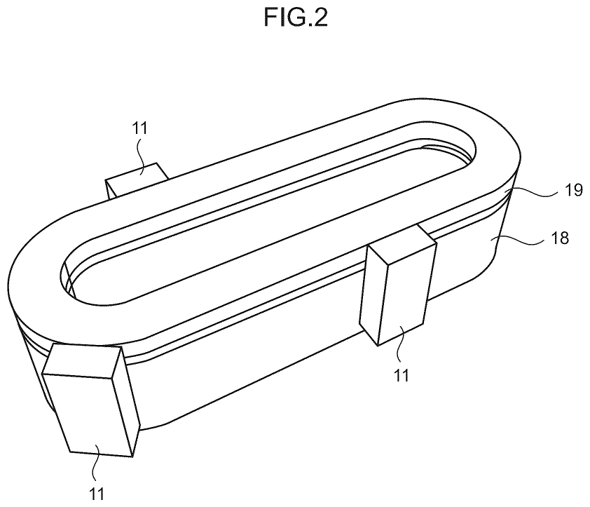

FIG. 2 is a diagram illustrating an example of a guide rail 18 and a position detection unit 19 included in the transfer system 1A according to the first embodiment. On a side surface of the transfer path 10, the guide rail 18 that guides the movement of each of the carriers 11 is installed. The carriers 11 are each attached to the side surface of the transfer path 10 via the guide rail 18. The carriers 11 move on the side surface of the transfer path 10 along the guide rail 18 and stop on the side surface of the transfer path 10. FIG. 2 illustrates three of the six carriers 11 illustrated in FIG. 1, and omits the illustration of the other three carriers 11. In the above description, the carriers 11 are attached to the side surface of the transfer path 10, but may be attached to an upper surface or a lower surface of the transfer path 10.

The position detection unit 19 detects the position of each of the plurality of the carriers 11 on the transfer path 10. The position detection unit 19 is attached to the upper surface of the transfer path 10. The position detection unit 19 is, for example, a linear scale including a plurality of position sensors. The position sensors are each a sensor that detects a magnetic field, such as a Hall sensor or a magnetoresistive sensor. The position sensors each detect the magnetic field of the permanent magnet 17 included in the carrier 11. The carrier 11 may include the permanent magnet 17 constituting the mover of the linear motor, and a permanent magnet for the linear scale. The position sensors may each detect a magnetic field of the permanent magnet for the linear scale included in the carrier 11.

The controller 13 acquires a result of detection by the position detection unit 19. The controller 13 controls each of the carriers 11 while checking the position of each of the carriers 11 on the basis of the result of detection by the position detection unit 19. Note that the position detection unit 19 need only be able to detect the position of each of the plurality of the carriers 11, and is not limited to the linear scale. Also, in the above description, the position detection unit 19 is attached to the upper surface of the transfer path 10, but may be attached to an area other than the upper surface of the transfer path 10.

On the transfer path 10, a reference point 15 is set as a reference of position in the forward direction that is one of the directions in which each of the plurality of the carriers 11 is moved. In the example illustrated in FIG. 1, the reference point 15 is set at a boundary between the transfer path unit 12a and the transfer path unit 12n. Note that the reference point 15 is not necessarily at the boundary between the transfer path unit 12a and the transfer path unit 12n. The reference point 15 can be set at any position on the transfer path 10.

Next, processing of assigning identification information to each of the plurality of the carriers 11 will be described. The transfer system 1A is, for example, started when the operation of a production line is started, and stopped when the operation of the production line is stopped. At startup of the transfer system 1A, the controller 13 executes the processing of assigning the identification information to each of the plurality of the carriers 11. The controller 13 assigns the identification information to each of the plurality of the carriers 11 to manage the plurality of the carriers 11, and controls each of the plurality of the carriers 11. As a result, while the transfer system 1A is in operation, each of the carriers 11 moving on the transfer path 10 is associated with a unique piece of the identification information. The transfer system 1A individually controls each of the plurality of the carriers 11 while identifying each of the plurality of the carriers 11 on the basis of the identification information. Note that managing the plurality of the carriers 11 specifically refers to associating each of the carriers 11 on the transfer path 10 with an operation pattern designated by a user. The operation pattern is a pattern of a mode of movement of the carrier 11.

When the transfer system 1A is powered off and stops the operation, the association between each of the plurality of the carriers 11 and the identification information is lost. At startup after stopping the operation, the transfer system 1A re-executes the processing of assigning the identification information to each of the plurality of the carriers 11.

The controller 13 assigns, to a first transferring body that is one of the plurality of the transferring bodies and is closest to the reference point 15 in the forward direction, first identification information that is a baseline of the identification information. In addition, the controller 13 assigns, to each of second transferring bodies that are the transferring bodies other than the first transferring body among the plurality of the transferring bodies, second identification information that is the identification information in sequence from the first identification information in the order of arrangement of the second transferring bodies in the forward direction.

When the transfer system 1A is in the state illustrated in FIG. 1, the first transferring body, which is the carrier 11 closest to the reference point 15 in the forward direction indicated by the arrow 16, is the carrier 11a. In addition, each of the carriers 11b, 11c, 11d, 11e, and 11f, which are the carriers 11 other than the carrier 11a, is the second transferring body.

In the first embodiment, the identification information is a number. The first identification information is a predetermined number. The second identification information is numbers that are in sequence in ascending or descending order from the number being the first identification information. Here, the first identification information is set to “N” as the predetermined number. The second identification information is numbers that are in sequence in ascending order from “N”, and is set to “N+1”, “N+2”, and so on. Here, “N” is any integer. When the numbers in sequence in ascending or descending order from the number being the first identification information are set as the second identification information, the transfer system 1A can assign, to each of the carriers 11, the identification information indicating the order of arrangement of the plurality of the carriers 11 in the direction of travel of the carriers 11.

In the processing of assigning the identification information to each of the plurality of the carriers 11, first, the transfer system 1A detects the position of each of the carriers 11 by the position detection unit 19. In a case where the position detection unit 19 is the above-described linear scale, the position detection unit 19 transmits information indicating whether or not the carrier 11 is detected by each position sensor to the controller 13. The controller 13 obtains the position of each of the plurality of the carriers 11 on the basis of the information from the position detection unit 19. Note that the transfer system 1A may detect the position of each of the carriers 11 by a method other than the above method. For example, the position detection unit 19 may obtain the position of each of the carriers 11 on the basis of the result of detection by each position sensor, and transmit position information indicating the position of each of the carriers 11 to the controller 13.

The controller 13 compares the position of each of the carriers 11 detected by the position detection unit 19 with the reference point 15, thereby identifying the carrier 11 being the first transferring body. That is, the controller 13 identifies the carrier 11 being the first transferring body on the basis of the result of detection by the position detection unit 19. When the transfer system 1A is in the state illustrated in FIG. 1, the controller 13 identifies the carrier 11a on the transfer path unit 12b as the first transferring body. The controller 13 associates the carrier 11a as the first transferring body with “N” as the first identification information. As described above, the controller 13 identifies the first transferring body and assigns the first identification information to the first transferring body.

Next, the controller 13 assigns, to the carriers 11b to 11f being the second transferring bodies, the second identification information that is the numbers in sequence in ascending order from “N” in the order of arrangement of the carriers 11b to 11f. That is, the carrier 11b, the carrier 11c, the carrier 11d, the carrier 11e, and the carrier 11f are assigned “N+1”, “N+2”, “N+3”, “N+4”, and “N+5”, respectively. As a result, the controller 13 associates the carrier 11b with “N+1” as the second identification information. The controller 13 associates the carrier 11c with “N+2” as the second identification information. The controller 13 associates the carrier 11d with “N+3” as the second identification information. The controller 13 associates the carrier 11e with “N+4” as the second identification information. The controller 13 associates the carrier 11f with “N+5” as the second identification information.

The controller 13 thus assigns the first identification information to the first transferring body and assigns the second identification information to the second transferring bodies in the order of arrangement of the second transferring bodies in the forward direction. Note that in a case where the second identification information is numbers that are in sequence in descending order from “N”, the second transferring bodies are assigned numbers such as “N−1”, “N−2”, and so on in the order of arrangement of the second transferring bodies in the forward direction. Note that whether the second identification information is the numbers in ascending order or the numbers in descending order is the same in every startup of the transfer system 1A.

When the controller 13 assigns, to each of the second transferring bodies that are the transferring bodies other than the first transferring body among the plurality of the transferring bodies, the second identification information that is the identification information in sequence from the first identification information, the controller 13 may assign the second identification information in the order of arrangement of the second transferring bodies in the backward direction opposite to the forward direction. The controller 13 may be set in advance whether the second identification information is assigned to each of the second transferring bodies in the order of arrangement of the second transferring bodies in the forward direction or in the order of arrangement of the second transferring bodies in the backward direction.

The transfer path 10 illustrated in FIG. 1 is a closed path and has no branch. On such a transfer path 10, while the transfer system 1A continues the operation, the order of arrangement of the plurality of the carriers 11 in the direction of travel of the carriers 11 is not changed. Therefore, the identification information assigned to each of the carriers 11 at startup of the transfer system 1A can accurately identify each of the carriers 11 moving on the transfer path 10.

According to the first embodiment, in the transfer system 1A, the reference point 15 is set on the transfer path 10, and the first transferring body that is one of the plurality of the carriers 11 and is closest to the reference point 15 in the forward direction is assigned the first identification information that is the baseline of the identification information. The transfer system 1A assigns, to each of the second transferring bodies that are the transferring bodies other than the first transferring body among the plurality of the carriers 11, the second identification information that is the identification information in sequence from the first identification information in the order of arrangement of the second transferring bodies in the forward direction or the backward direction. As a result, the transfer system 1A can associate each of the plurality of the carriers 11 with the unique piece of the identification information, and can identify each of the plurality of the carriers 11 on the basis of the identification information. The transfer system 1A can identify each of the plurality of the carriers 11 without separately preparing the carrier 11 provided with a structure as a characteristic for identification and the carrier 11 not provided with such a structure. Moreover, the transfer system 1A according to the first embodiment does not require installation of a detection unit for identifying the carriers 11, the detection unit being different from the position detection unit 19 that performs position detection for controlling the carriers 11.

The transfer system 1A thus has an effect that each of the plurality of the transferring bodies can be identified with the simple configuration. Since the transfer system 1A can have the simple configuration, it is possible to prevent an increase in the manufacturing cost of the transfer system 1A.

### Second Embodiment

In the first embodiment, the first identification information assigned to the first transferring body is the predetermined number. A second embodiment will describe an example in which any number can be set as the first identification information.

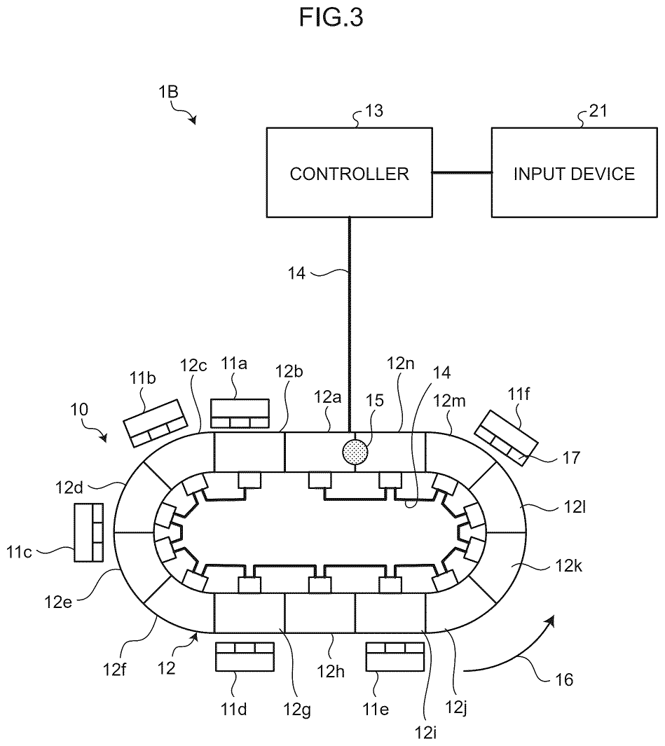

FIG. 3 is a diagram illustrating an exemplary configuration of a transfer system 1B according to the second embodiment. The transfer system 1B includes an input device 21 in addition to configurations similar to those of the transfer system 1A illustrated in FIG. 1. In the second embodiment, the components identical to those in the above first embodiment are denoted by the same reference numerals as those assigned to such components in the first embodiment, and a configuration different from that of the first embodiment will be mainly described.

The input device 21 is connected to the controller 13. A number to be set as the first identification information is input to the input device 21. The input device 21 is a device for input to be operated by a user of the transfer system 1B. The input device 21 includes, for example, a keyboard, a mouse, a keypad, a touch panel, or the like. The input device 21 transmits the input number to the controller 13. The controller 13 receives the number transmitted from the input device 21, and sets the received number as the first identification information.

The user inputs any integer (i.e., a desired integer) to the input device 21. Here, it is assumed that the number input to the input device 21 is “M”. Similarly to the first embodiment, the controller 13 identifies the carrier 11 that is the first transferring body. The controller 13 associates the identified carrier 11 with “M” as the first identification information. The controller 13 thus assigns “M” as the first identification information to the carrier 11 that is the first transferring body.

Next, the controller 13 assigns the second identification information to each of the carriers 11 that are the second transferring bodies. In the second embodiment, the second identification information is numbers that are in sequence in ascending or descending order from the number set as the first identification information. Here, the second identification information is numbers in sequence in ascending order from “M”, and is set to “M+1”, “M+2”, and so on. The controller 13 assigns, to the carriers 11 being the second transferring bodies, the numbers in sequence in ascending order from “M” in the order of arrangement of the carriers 11 being the second transferring bodies.

The controller 13 thus assigns, to the first transferring body, the first identification information being any number, and assigns, to each of the second transferring bodies, the second identification information in the order of arrangement of the second transferring bodies in the forward direction or the backward direction. Note that, for example, it is assumed that the transfer system 1B includes six units of the carriers 11, and numbers “1”, “2”, “3”, “4”, “5”, and “6” are assigned to corresponding ones of the carriers 11. In a case where the number input to the input device 21 is “5”, the ascending order from “5” corresponds to the numbers in the order of “6”, “1”, “2”, “3”, and “4”. That is, in the case of ascending order, the number following the largest number among the plurality of numbers is the smallest number among the plurality of numbers.

In a case where the second identification information is numbers that are in sequence in descending order from “M”, the second transferring bodies are assigned numbers such as “M−1”, “M−2”, and so on in the order of arrangement of the second transferring bodies in the forward direction or the backward direction. Note that in the case of descending order, the number following the smallest number among the plurality of numbers is the largest number among the plurality of numbers.

For example, among the plurality of the carriers 11, the user recognizes by sight or the like the carrier 11 closest to the reference point 15 in the forward direction, that is, the carrier 11 as the first transferring body at startup. The user determines the number assigned to the carrier 11 in the previous operation of the transfer system 1B, and inputs the same number as the determined number to the input device 21. As a result, the transfer system 1B can assign the same identification information as that assigned in the previous operation of the transfer system 1B to each of the plurality of the carriers 11. In this case, even when the carrier 11 as the first transferring body is changed at each startup of the transfer system 1B, the transfer system 1B can assign the same identification information to each of the plurality of the carriers 11 in each operation.

Alternatively, in a case where the carriers 11 of different types are included in the plurality of the carriers 11 with the carriers 11 of each type being arranged in a predetermined pattern, the number to be input may be determined in advance for each type. The user inputs the number corresponding to the type of the carrier 11 being the first transferring body to the input device 21. The transfer system 1B can input any number and thus can assign the numbers to the carriers 11 with a high degree of freedom.

According to the second embodiment, the transfer system 1B inputs the number set as the first identification information to the input device 21, thereby being able to assign the numbers to the carriers 11 with a high degree of freedom.

### Third Embodiment

As one aspect of the second embodiment, the example has been described in which the user recognizes the carrier 11 being the first transferring body and inputs the same identification information as the identification information assigned to the carrier 11 in the previous operation, thereby assigning the same identification information to each of the plurality of the carriers 11 in each operation. A third embodiment will describe an example in which the same identification information as the identification information assigned to the first transferring body in the previous operation is automatically assigned to the first transferring body.

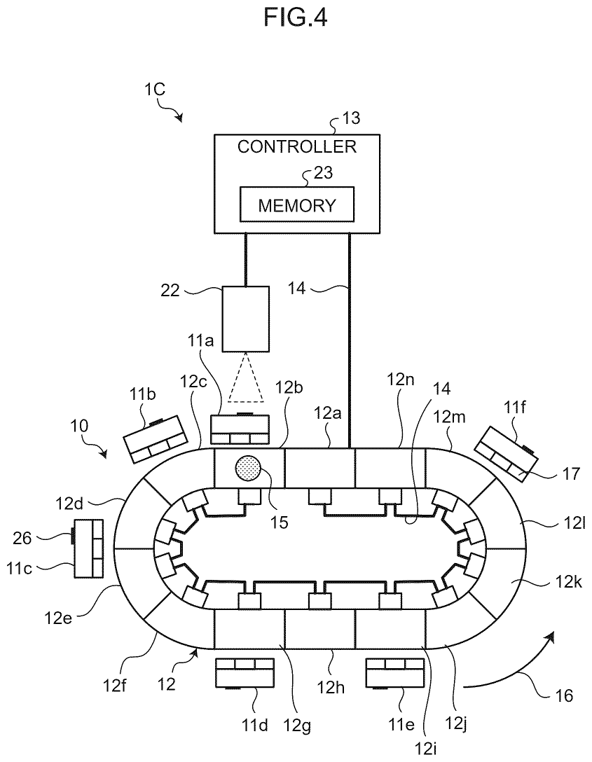

FIG. 4 is a diagram illustrating an exemplary configuration of a transfer system 1C according to the third embodiment. The transfer system 1C includes a reading device 22 in addition to configurations similar to those of the transfer system 1A illustrated in FIG. 1. In the third embodiment, the components identical to those in the above first or second embodiment are denoted by the same reference numerals as those assigned to such components in the first or second embodiment, and a configuration different from that of the first or second embodiment will be mainly described.

In the third embodiment, each of the plurality of the carriers 11 is provided with an individual identifier 26 that is unique to each of the carrier 11. The controller 13 holds the identification information assigned to each of the plurality of the carriers 11 in association with the individual identifier 26. At startup of the transfer system 1C, the controller 13 assigns the identification information associated with the individual identifier 26 of the first transferring body to the first transferring body as the first identification information.

The individual identifier 26 is, for example, an identifier such as a barcode or a two-dimensional code, a radio frequency identification (RFID) tag, or the like. In the case where the individual identifier 26 is the barcode or the two-dimensional code, the reading device 22 is an optical device such as an optical reading device or a camera. In the case where the individual identifier 26 is the RFID tag, the reading device 22 is an RFID reader.

The reading device 22 is connected to the controller 13. The reading device 22 reads the individual identifier 26 provided to the first transferring body, and transmits the individual identifier 26 that has been read to the controller 13. As a result, the controller 13 acquires the individual identifier 26 that has been read.

In the example illustrated in FIG. 4, the reading device 22 is assumed to be the optical reading device. The optical reading device obtains an identifier by emitting light and reading reflected light. In FIG. 4, the light being emitted from the reading device 22 is represented by a broken line. The reading device 22 reads the individual identifier 26 of the carrier 11 that has entered a detection range of the reading device 22. The detection range is a range in which the reading device 22 can read the individual identifier 26, and substantially coincides with a range irradiated with the light from the reading device 22. In the example illustrated in FIG. 4, the reading device 22 is disposed to face the side surface of the transfer path 10 and emits the light toward the side surface of the transfer path 10. In the example illustrated in FIG. 4, the individual identifier 26 is provided on a surface of the carrier 11 opposite to a surface thereof facing the side surface of the transfer path 10.

In the example illustrated in FIG. 4, the reference point 15 is a position within the transfer path unit 12b. Moreover, the reading device 22 faces the transfer path unit 12b. Thus, in the example illustrated in FIG. 4, the reference point 15 is set in accordance with the position of the reading device 22.

The transfer system 1C holds an identification information table in which the individual identifier 26 and the identification information are associated with each other. In the example illustrated in FIG. 4, the identification information table is stored in a memory 23 inside the controller 13. The memory 23 is a non-volatile memory, The individual identifier 26 is, for example, a number unique to each of the carriers 11. A number being the identification information may be matched with the number being the individual identifier 26, or may be different from the number being the individual identifier 26.

In processing of assigning the identification information to each of the plurality of the carriers 11, first, the transfer system 1C detects the position of each of the carriers 11 by the position detection unit 19. In a case where the first transferring body, which is the carrier 11 closest to the reference point 15 in the forward direction, is within the detection range of the reading device 22, the reading device 22 reads the individual identifier 26 of the carrier 11. In a case where the carrier 11 closest to the reference point 15 in the forward direction is out of the detection range of the reading device 22, the controller 13 controls to move the carriers 11 in the forward direction until the carrier 11 reaches the detection range of the reading device 22. The reading device 22 reads the individual identifier 26 of the carrier 11 that has reached the detection range of the reading device 22.

If the reading device 22 is located away from the reference point 15, when the second transferring body exists between the first transferring body closest to the reference point 15 and the reading device 22, the reading device 22 may erroneously read the individual identifier 26 of the second transferring body. In the third embodiment, the reference point 15 is set in accordance with the position of the reading device 22, so that it is possible to prevent the reading device 22 from erroneously reading the individual identifier 26 of the second transferring body.

The controller 13 acquires the individual identifier 26 of the carrier 11 being the first transferring body and then reads, from the identification information table, the identification information associated with the individual identifier 26 identical to the individual identifier 26 that has been read. The controller 13 assigns the read identification information to the carrier 11 being the first transferring body. Next, similarly to the case of the first embodiment, the controller 13 assigns the identification information, which is in sequence in ascending order from the identification information assigned to the carrier 11 being the first transferring body, or the identification information, which is in sequence in descending order from the identification information assigned to the carrier 11 being the first transferring body, to each of the carriers 11 being the second transferring bodies.

The controller 13 thus assigns the first identification information to the first transferring body and assigns the second identification information to each of the second transferring bodies. As a result, the controller 13 can assign the same identification information to each of the plurality of the carriers 11 in each operation.

In the above description, the individual identifier 26 is provided on one surface of the carrier 11, but the individual identifier 26 may be provided on each of two or more surfaces of the carrier 11. The individual identifier 26 is provided, for example, on at least two surfaces among an upper surface, the side surface, and a lower surface of the carrier 11. The individual identifier 26 being provided on many surfaces allows for a higher degree of freedom in position and posture of the reading device 22 when the reading device 22 is ready for reading the individual identifier 26.

In the above description, the memory 23 inside the controller 13 stores the identification information table, but the identification information table may be stored in a non-volatile memory that is an external storage device of the controller 13. In this case, the controller 13 acquires, from the identification information table stored in the external storage device, the identification information associated with the individual identifier 26 identical to the individual identifier 26 that has been read by the reading device 22.

According to the third embodiment, the transfer system 1C holds the identification information assigned to each of the plurality of the transferring bodies in association with the individual identifier 26. At startup of the transfer system 1C, the transfer system 1C assigns the identification information associated with the individual identifier 26 of the first transferring body to the first transferring body as the first identification information. The transfer system 1C automatically assigns the same identification information as the identification information assigned to the first transferring body in the previous operation to the first transferring body. As a result, the transfer system 1C can automatically assign the same identification information to each of the plurality of the carriers 11 in each operation. In the transfer system 1C in which the transferring body is provided with the individual identifier 26, all the transferring bodies in the transfer system 1C are provided with the individual identifiers 26 so that it is not necessary to separately prepare the carriers 11 having different configurations. As a result, the transfer system 1C can have the simple configuration, which can prevent an increase in the manufacturing cost of the transfer system 1C.

### Fourth Embodiment

The third embodiment has described the example in which the same identification information as the identification information assigned to the first transferring body in the previous operation is automatically assigned to the first transferring body. A fourth embodiment will describe another example in which the same identification information as the identification information assigned to the first transferring body in the previous operation is automatically assigned to the first transferring body.

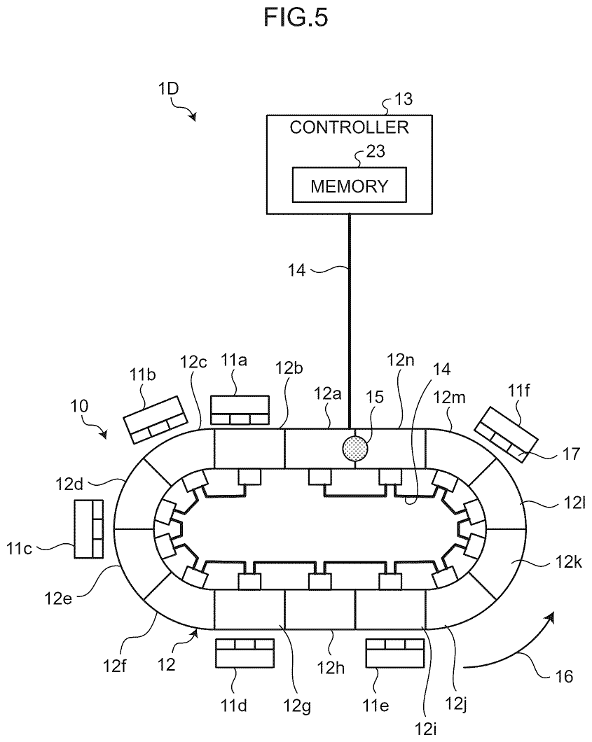

FIG. 5 is a diagram illustrating an exemplary configuration of a transfer system 1D according to the fourth embodiment. The transfer system 1D includes configurations similar to those of the transfer system 1A illustrated in FIG. 1. In the fourth embodiment, the components identical to those in the above first to third embodiments are denoted by the same reference numerals as those assigned to such components in the first to third embodiments, and a configuration different from that of the first to third embodiments will be mainly described.

In the fourth embodiment, the controller 13 periodically stores position information in association with the identification information in the memory 23, the position information indicating the position of each of the plurality of the carriers 11 on the transfer path 10, the identification information being assigned to each of the plurality of the carriers 11. At startup of the transfer system 1D, the controller 13 acquires startup position information indicating the position of each of the plurality of the carriers 11 at startup. The controller 13 reads, from the memory 23, latest position information that is the position information stored in the memory 23 and is the latest piece of the position information before startup. The controller 13 compares the latest position information with the startup position information. Through the comparison, the controller 13 specifies, for each of the plurality of the carriers 11 at startup, the carrier 11 of which the position indicated by the latest position information is the closest along the transfer path 10 from the position indicated by the startup position information. The controller 13 assigns the identification information associated with the latest position information of the carrier 11 that has been specified to each of the plurality of the carriers 11 at startup.

For example, it is assumed that when an unexpected alarm shuts off the power supply of the transfer system 1D, the transfer system 1D is restarted. At the time of restart, the controller 13 acquires the startup position information of each of the plurality of the carriers 11 by the position detection unit 19. The controller 13 reads the latest position information of each of the carriers 11 from the memory 23. Next, the controller 13 compares the startup position information with the latest position information and assigns, to the carrier 11 at the position closest to the position indicated by the latest position information, the identification information associated with the latest position information. The controller 13 assigns the identification information to each of the plurality of the carriers 11.

In the third embodiment, when the carrier 11 closest to the reference point 15 is out of the detection range of the reading device 22, the controller 13 controls to move the carriers 11 in the forward direction and assigns the identification information to each of the plurality of the carriers 11. On the other hand, in the fourth embodiment, the controller 13 can assign the identification information to each of the plurality of the carriers 11 without controlling to move the carriers 11. Therefore, according to the fourth embodiment, it is possible to quickly and automatically assign the identification information to each of the plurality of the carriers 11 at startup.

In the above description, the memory 23 inside the controller 13 stores the position information and the identification information, but the transfer system 1D may store the position information and the identification information in a non-volatile memory that is an external storage device of the controller 13.

According to the fourth embodiment, the transfer system 1D periodically stores the position information in association with the identification information. The transfer system 1D specifies, for each of the plurality of the carriers 11, the carrier 11 of which the position indicated by the latest position information is the closest along the transfer path 10 from the position indicated by the startup position information, and assigns the identification information associated with the latest position information of the carrier 11 that has been specified to each of the plurality of the carriers 11. As a result, the transfer system 1D can automatically assign the same identification information to each of the plurality of the carriers 11 in each operation.

### Fifth Embodiment

A fifth embodiment will describe a method of estimating a remaining life of each of the plurality of the carriers 11 and exchanging identification numbers between the carriers 11 on the basis of the estimated remaining life. The fifth embodiment will also describe an example in which machine learning is applied to estimate the remaining life.

In the transfer systems 1A to 1D according to the first to fourth embodiments, there is a case where the carriers 11 are moved in the mode different for each of the carriers 11, so that the load applied to the carriers 11 varies for each of the carriers 11. For example, the longer the cumulative time for moving the carrier 11 becomes, the larger the load applied to the carrier 11 becomes. Also, the more frequently the acceleration is changed or the more a rapid change in the acceleration occurs, the larger the load applied to the carrier 11 becomes.

When the load applied to the carriers 11 is imbalanced, the remaining life of the carriers 11 varies. The remaining life is a period until the carrier 11 receives maintenance. The maintenance includes a case where the carrier 11 is repaired and a case where the carrier 11 is replaced. The larger the variation in the remaining life of the plurality of the carriers 11 in the transfer systems 1A to 1D, the more frequently the transfer systems 1A to 1D are stopped for the maintenance of the carrier 11, which hinders the operation efficiency of the transfer systems 1A to 1D. In order to solve this problem, in the fifth embodiment, the remaining life of each of the plurality of the carriers 11 is estimated, and the identification numbers are exchanged such that the remaining lives of the carriers 11 become uniform.

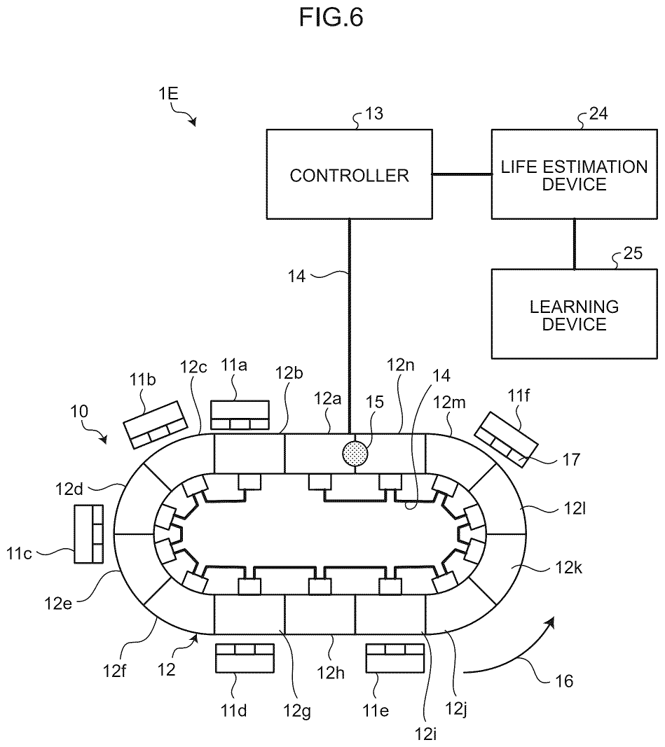

FIG. 6 is a diagram illustrating an exemplary configuration of a transfer system 1E according to the fifth embodiment. The transfer system 1E includes a life estimation device 24 and a learning device 25 in addition to configurations similar to those of the transfer system 1A illustrated in FIG. 1. In the fifth embodiment, the components identical to those in the above first to fourth embodiments are denoted by the same reference numerals as those assigned to such components in the first to fourth embodiments, and a configuration different from that of the first to fourth embodiments will be mainly described.

The life estimation device 24 is connected to the controller 13. The life estimation device 24 estimates the remaining life for each of the plurality of the carriers 11. The learning device 25 is connected to the life estimation device 24. The learning device 25 learns a relationship between operation state data and operation history data and the remaining life. The operation state data and the operation history data will be described later in detail. The life estimation device 24 estimates the remaining life on the basis of a result of learning by the learning device 25.

The controller 13 exchanges the identification information assigned to each of the plurality of the carriers 11 on the basis of a result of estimation of the remaining life for each of the plurality of the carriers 11. The controller 13 performs adjustment to equalize the future remaining life of each of the plurality of the carriers 11 by exchanging the identification information assigned to each of the plurality of the carriers 11.

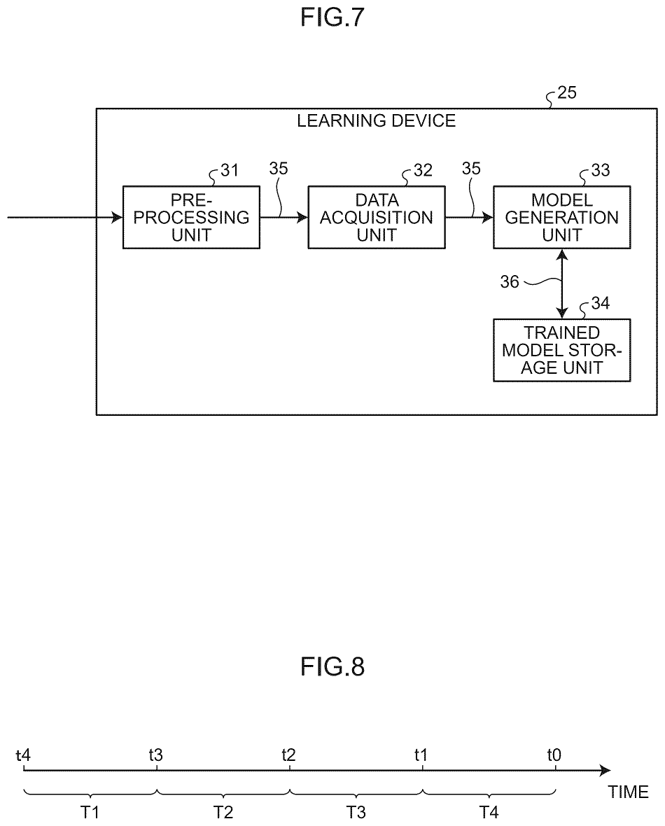

FIG. 7 is a diagram illustrating an exemplary configuration of the learning device 25 included in the transfer system 1E according to the fifth embodiment. The learning device 25 includes a preprocessing unit 31, a data acquisition unit 32, a model generation unit 33, and a trained model storage unit 34.

The preprocessing unit 31 executes preprocessing on data input to the learning device 25. The preprocessing unit 31 receives the operation state data of each of the carriers 11, the operation history data of each of the carriers 11, and maintenance information of each of the carriers 11.

The operation state data is data indicating the mode of movement of the carrier 11. The operation state data includes various data such as the weight of a jig attached to the carrier 11, the weight of a workpiece placed on the carrier 11, the frequency of acceleration, the frequency of deceleration, the thrust at the time of acceleration, the thrust at the time of deceleration, the speed of movement, the vibration frequency of the carrier 11, or the magnitude of the vibration of the carrier 11. The operation state data includes, for example, data acquired when the carrier 11 is actually moved. The data included in the operation state data need only be data related to the mode of movement of the carrier 11, and is not limited to those exemplified here.

The operation state data may be a single numerical value such as a numerical value indicating the weight of the workpiece, or may be time-series data. The time-series data is, for example, a series of values obtained by sampling a time-varying value in a certain period, and includes data of the speed of movement of the carrier 11 or the like.

The operation history data is data indicating a history of operation of the carrier 11. The operation history data includes various data such as a cumulative operation time of the carrier 11, a cumulative distance of movement of the carrier 11, or a cumulative count of the carrier 11 passing over a guide provided on the transfer path 10. The data included in the operation history data need only be data related to the history of movement of the carrier 11, and is not limited to those exemplified here.

The operation state data or the operation history data is stored in, for example, a non-volatile memory in the controller 13. The non-volatile memory is not illustrated. The preprocessing unit 31 reads the operation state data or the operation history data from the non-volatile memory. The operation state data or the operation history data may be stored in a non-volatile memory that is an external storage device of the controller 13.

The maintenance information is data indicating a

track record of the maintenance of the carrier 11. The maintenance information is recorded by, for example, an operator who performs the maintenance. The maintenance information includes data of the date and time when the maintenance of the carrier 11 is performed and information indicating the details of the maintenance.

FIG. 8 is a diagram for explaining data preprocessing in the preprocessing unit 31 included in the learning device 25 according to the fifth embodiment. The preprocessing unit 31 collects the operation state data and the operation history data for a period preceding the date and time indicated in the maintenance information. The preprocessing unit 31 divides the period preceding the date and time indicated in the maintenance information into a plurality of periods, and classifies each of the operation state data collected and the operation history data collected into the periods.

The horizontal axis illustrated in FIG. 8 represents time as the remaining life. Here, “t0” is when the maintenance is performed, that is, when the carrier 11 reaches the end of its life. Moreover, “t4” is when the carrier 11 starts to be used in the transfer system 1E. In the example illustrated in FIG. 8, the preprocessing unit 31 divides the period from “t4” to “t0” into four periods of T1 to T4, and classifies each of the operation state data collected and each of the operation history data collected as data in the periods. The period TI corresponds to the period from “t4” to “t3”. The period T2 corresponds to the period from “t3” to “t2”. The period T3 corresponds to the period from “t2” to “t1”. The period T4 corresponds to the period from “t1” to “t0”. The preprocessing unit 31 generates remaining life data corresponding to each of the classified data. The remaining life data is data indicating the time left until the carrier 11 reaches the end of its life. The remaining life data is, for example, data indicating the classification of the period. The remaining life data generated in the preprocessing unit 31 indicates the remaining life obtained on the basis of the actual life of the carrier 11.

The preprocessing unit 31 creates a data set that is a set of state variables and the remaining life data, the state variables including the operation state data and the operation history data. The data acquisition unit 32 acquires learning data 35 that is the data set created by the preprocessing unit 31. The learning data 35 is the data in which the operation state data, the operation history data, and the remaining life data are associated with one another. As just described, the data acquisition unit 32 acquires the learning data 35 including the operation state data that is the data indicating the mode of movement of the carrier 11, the operation history data that is the data indicating the history of operation of the carrier 11, and the remaining life data indicating the remaining life obtained on the basis of the actual life of the carrier 11. The data acquisition unit 32 outputs the learning data 35 acquired to the model generation unit 33.

The model generation unit 33 generates, on the basis of the learning data 35, a trained model 36 for inferring the remaining life from the operation state data and the operation history data. The model generation unit 33 generates the trained model 36 by learning a relationship between the operation state data and operation history data and the remaining life data. The trained model 36 is stored in the trained model storage unit 34.

A learning algorithm used by the model generation unit 33 can be a known algorithm such as supervised learning, unsupervised learning, or reinforcement learning. As an example, a case where a neural network is applied will be described.

For example, according to a neural network model, the model generation unit 33 uses so-called supervised learning to learn the relationship between the operation state data and operation history data and the remaining life data. Here, supervised learning is a method that gives data sets of input and result to the learning device 25, learns features in the learning data 35, and infers the result from the input.

The learning data 35 includes the input and a label that is the result corresponding to the input. The operation state data and the operation history data correspond to the input. The remaining life data is training data and corresponds to the label. The neural network includes an input layer including a plurality of neurons, a hidden layer that is a middle layer including a plurality of neurons, and an output layer including a plurality of neurons. The middle layer may be one layer or two or more layers.

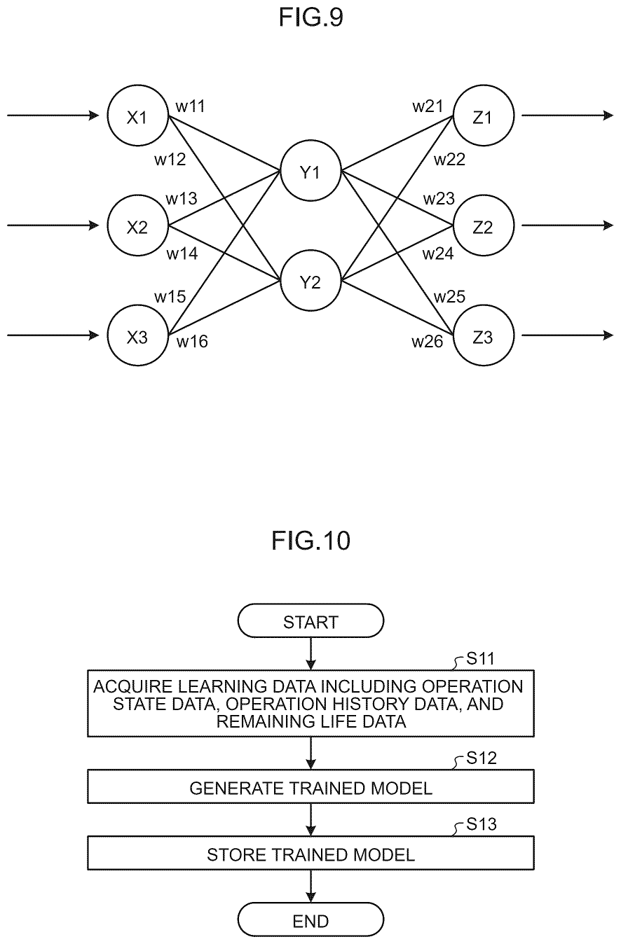

FIG. 9 is a diagram illustrating an exemplary configuration of the neural network used for learning in the learning device 25 according to the fifth embodiment. The neural network illustrated in FIG. 9 is a three-layer neural network. The input layer includes neurons X1, X2, and X3. The middle layer includes neurons Y1 and Y2. The output layer includes neurons Z1, Z2, and Z3. Note that each layer may include any number of neurons. A plurality of values which are input to the input layer are multiplied by weights w11, w12, w13, w14, w15, and w16, which are weights W1, and are then input to the middle layer. A plurality of values input to the middle layer are multiplied by weights w21, w22, w23, w24, w25, and w26, which are weights W2, and are then output from the output layer. The output result output from the output layer changes according to the values of the weights W1 and W2.

In the fifth embodiment, the neural network learns the remaining life by so-called supervised learning according to the learning data 35 acquired by the data acquisition unit 32. That is, the neural network learns the remaining life by adjusting the weights W1 and W2 such that the result output from the output layer by inputting the operation state data and the operation history data to the input layer is close to the remaining life data. The model generation unit 33 executes learning as described above to generate the trained model 36 and outputs the trained model 36. The trained model storage unit 34 stores the trained model 36 output from the model generation unit 33. The model generation unit 33 may read the trained model 36 already generated from the trained model storage unit 34, and update the trained model 36 by relearning according to the learning data 35.

Next, learning processing by the learning device 25 will be described. FIG. 10 is a flowchart illustrating a procedure of the learning processing by the learning device 25 according to the fifth embodiment. In step S11, the learning device 25 acquires the learning data 35 including the operation state data, the operation history data, and the remaining life data by the preprocessing unit 31 and the data acquisition unit 32. For example, the learning device 25 simultaneously acquires the operation state data, the operation history data, and the remaining life data. The learning device 25 only needs to be able to acquire the learning data 35 in which the operation state data, the operation history data, and the remaining life data are associated with each other, and may acquire the operation state data, the operation history data, and the remaining life data at different timings.

In step S12, the model generation unit 33 generates the trained model 36 by so-called supervised learning in accordance with the learning data 35 acquired in step S11. In step S13, the trained model storage unit 34 stores the trained model 36 generated in step S12. After the above steps, the learning device 25 ends the learning processing according to the procedure illustrated in FIG. 10. The learning device 25 may update the trained model 36 by learning processing similar to that when generating the trained model 36.

In the example illustrated in FIG. 6, the learning device 25 is a device external to the controller 13. The learning device 25 may be a device connectable to the controller 13 via a network. The learning device 25 may be a device on a cloud server. Note that the learning device 25 may be a device built in the controller 13. In the example illustrated in FIG. 7, the trained model storage unit 34 is built in the learning device 25. The trained model storage unit 34 may be provided outside the learning device 25.

The learning device 25 may learn the remaining life according to data sets created for a plurality of the transfer systems 1E. The learning device 25 may acquire the operation state data, the operation history data, and the maintenance information from a plurality of the transfer systems 1E used in the same place, or may acquire the operation state data, the operation history data, and the maintenance information from a plurality of the transfer systems 1E used in different places. The operation state data, the operation history data, and the maintenance information may be collected from a plurality of the transfer systems 1E that operates independently of each other in a plurality of places. After the operation state data, the operation history data, and the maintenance information start to be collected from the plurality of the transfer systems 1E, a new transfer system 1E may be added to the targets from which the operation state data, the operation history data, and the maintenance information are collected. Also, after the operation state data, the operation history data, and the maintenance information start to be collected from the plurality of the transfer systems 1E, some of the plurality of the transfer systems 1E may be excluded from the targets from which the operation state data, the operation history data, and the maintenance information are collected.

The learning device 25 that has performed learning for one of the transfer systems 1E may perform learning for a different one of the transfer systems 1E. The learning device 25 that performs learning for the different one of the transfer systems 1E can update the trained model 36 by performing relearning for the different one of the transfer systems 1E.

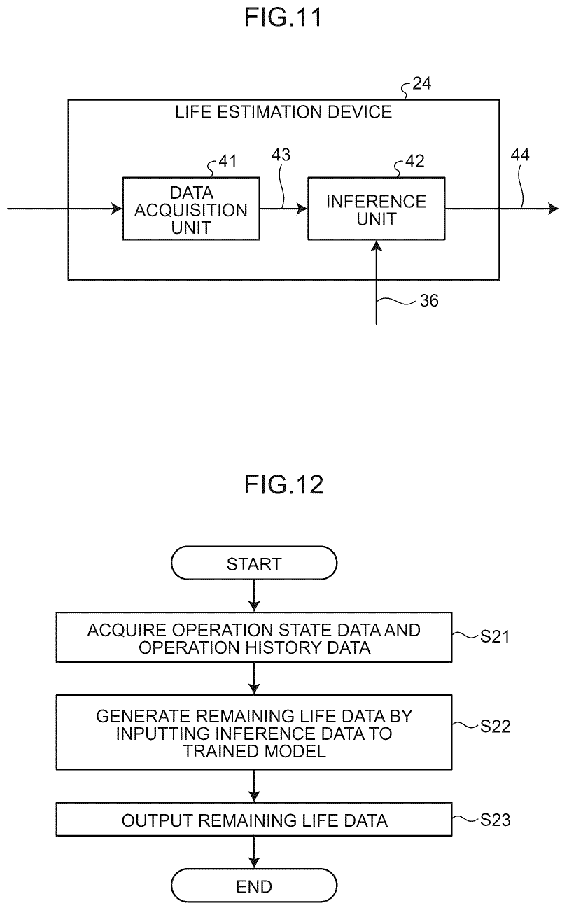

FIG. 11 is a diagram illustrating an exemplary configuration of the life estimation device 24 included in the transfer system 1E according to the fifth embodiment. The life estimation device 24 includes a function as an inference device that infers the remaining life from the operation state data and the operation history data. The life estimation device 24 includes a data acquisition unit 41 and an inference unit 42.

The data acquisition unit 41 receives the operation state data and the operation history data for each of the plurality of the carriers 11 included in the transfer system 1E. The data acquisition unit 41 thus acquires the operation state data and the operation history data for each of the plurality of the carriers 11. The data acquisition unit 41 outputs inference data 43, which is the acquired operation state data and operation history data, to the inference unit 42. The trained model 36 stored in the trained model storage unit 34 of the learning device 25 is input to the inference unit 42. The inference unit 42 inputs the operation state data and the operation history data to the trained model 36, thereby inferring the remaining life of each of the plurality of the carriers 11. The inference unit 42 outputs remaining life data 44, which is a result of inference of the remaining life, to the controller 13.

FIG. 12 is a flowchart illustrating a procedure of inference processing by the life estimation device 24 according to the fifth embodiment. In step S21, the life estimation device 24 acquires the operation state data and the operation history data by the data acquisition unit 41.

In step S22, the inference unit 42 generates the remaining life data 44 by inputting the inference data 43 to the trained model 36. In step S23, the inference unit 42 outputs the remaining life data 44 generated in step S22. After the above steps, the life estimation device 24 ends the processing according to the procedure illustrated in FIG. 12.

In the example illustrated in FIG. 6, the life estimation device 24 is a device external to the controller 13. The life estimation device 24 may be a device connectable to the controller 13 via a network. The life estimation device 24 may be a device on a cloud server. Note that the life estimation device 24 may be a device built in the controller 13.

The description has been made of the example where supervised learning is applied as the learning algorithm used by the model generation unit 33, but learning other than supervised learning may be applied as the learning algorithm. Reinforcement learning, unsupervised learning, semi-supervised learning, or the like may be applied as the learning algorithm. The model generation unit 33 may execute machine learning using a learning algorithm such as deep learning, genetic programming, inductive logic programming, or support vector machine other than the neural network.

The controller 13 acquires the remaining life data 44 for each of the plurality of the carriers 11 from the life estimation device 24. The controller 13 refers to the remaining life data 44 of the carriers 11 and appropriately exchanges the identification information assigned to the carriers 11. The controller 13 exchanges the identification information between the carriers 11 to exchange the operation patterns between the carriers 11.

On the basis of the result of estimation of the remaining life for each of the plurality of the carriers 11, the controller 13 exchanges, for example, between the identification information of the carrier 11 having the shortest estimated remaining life among the plurality of the carriers 11 and the identification information of the carrier 11 having the longest estimated remaining life among the plurality of the carriers 11. By exchanging the identification information, an operation pattern with a large load is applied to the carrier 11 having the longest remaining life among the plurality of the carriers 11, and an operation pattern with a small load is applied to the carrier 11 having the shortest remaining life among the plurality of the carriers 11. By exchanging the operation patterns, the future remaining lives of the carriers 11 are equalized. The controller 13 thus performs adjustment to equalize the future remaining life of each of the plurality of the carriers 11 by exchanging the identification information assigned to each of the plurality of the carriers 11 on the basis of the result of estimation of the remaining life for each of the plurality of the carriers 11.

According to the fifth embodiment, the transfer system 1E includes the learning device 25 and the life estimation device 24 that is the inference device, thereby being able to estimate the remaining lives of the carriers 11. Moreover, the transfer system 1E performs adjustment to equalize the future remaining life of each of the plurality of the carriers 11 by exchanging the identification information on the basis of the result of estimation of the remaining life. This as a result can reduce the frequency of stopping the transfer system 1E for maintenance of the carrier 11 and improve the operation efficiency of the transfer system 1E.

Note that, in the transfer system 1E according to the fifth embodiment, the controller 13 may exchange the identification information assigned to each of the plurality of the transferring bodies in any manner on the basis of the result of estimation of the remaining life. For example, the controller 13 may be set to exchange between the identification information of the carrier 11 having the shortest estimated remaining life among the plurality of the carriers 11 and the identification information of the carrier 11 having the second shortest estimated remaining life among the plurality of the carriers 11. That is, the transfer system 1E performs adjustment to equalize the future remaining lives of the two carriers 11 having the short remaining lives among the plurality of the carriers 11. Such a configuration can also reduce the frequency of stopping the transfer system 1E for maintenance of the carrier 11 and improve the operation efficiency of the transfer system 1E.

In the transfer system 1E according to the fifth embodiment, the life estimation device 24 has been described as the device that infers the remaining life by the inference unit 42 using the trained model 36. However, the life estimation device 24 is not limited to such a configuration. For example, the life estimation device 24 may be a device that stores a data table in which the operation state data, the operation history data, and the remaining life data are associated with one another, and outputs the remaining life by collation with the data table when at least one of the operation state data and the operation history data is input. The life estimation device 24 can output the remaining life even with such a configuration not using the trained model 36.

Next, hardware for implementing the controller 13 according to the first to fifth embodiments will be described. The controller 13 is implemented by processing circuitry. The processing circuitry may be circuitry in which a processor executes software, or may be dedicated circuitry.

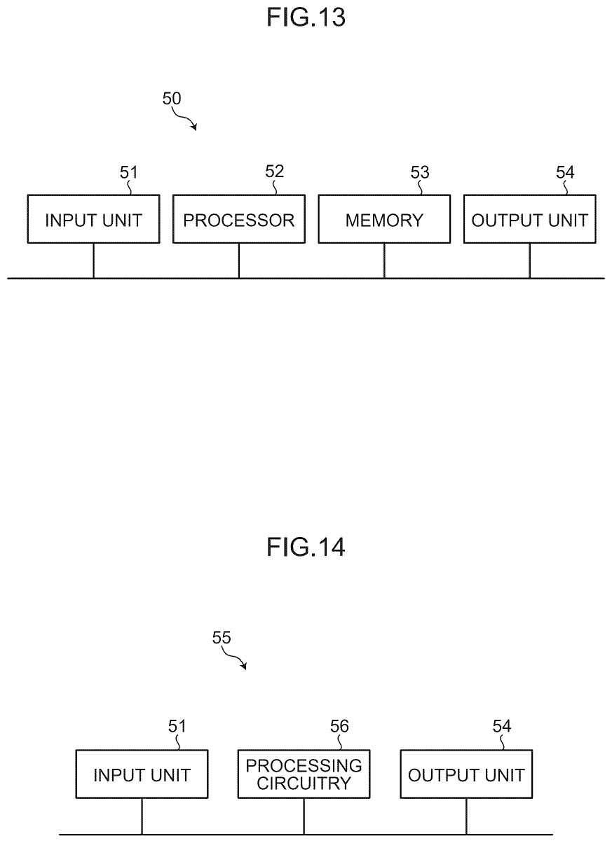

In the case where the processing circuitry is implemented by the software, the processing circuitry is, for example, a control circuit 50 illustrated in FIG. 13. FIG. 13 is a diagram illustrating an exemplary configuration of the control circuit 50 according to the first to fifth embodiments. The control circuit 50 includes an input unit 51, a processor 52, a memory 53, and an output unit 54. The input unit 51 is an interface circuit that receives data input from the outside of the control circuit 50 and gives the data to the processor 52. The output unit 54 is an interface circuit that sends data from the processor 52 or the memory 53 to the outside of the control circuit 50.

In the case where the processing circuitry is the control circuit 50 illustrated in FIG. 13, the controller 13 is implemented by software, firmware, or a combination of software and firmware. The software or firmware is described as programs and stored in the memory 53. The processing circuitry implements the functions of the controller 13 by the processor 52 reading and executing the programs stored in the memory 53. That is, the processing circuitry includes the memory 53 for storing the programs, the execution of which results in the execution of the processing of the controller 13. It can also be said that these programs cause a computer to execute procedures and methods related to the controller 13.

The processor 52 is a central processing unit (CPU). The processor 52 may be a central processor, a processing unit, an arithmetic unit, a microprocessor, a microcomputer, a processor, or a digital signal processor (DSP). The memory 53 corresponds to, for example, a non-volatile or volatile semiconductor memory such as a random access memory (RAM), a read only memory (ROM), a flash memory, an erasable programmable read only memory (EPROM), or an electrically erasable programmable read only memory (EEPROM (registered trademark)), a magnetic disk, a flexible disk, an optical disk, a compact disc, a mini disc, a digital versatile disc (DVD), or the like.

FIG. 13 is the example of the hardware in the case where the controller 13 is implemented by the processor 52 and the memory 53 that are for general purpose use, but the controller 13 may be implemented by a hardware circuit that is dedicated. FIG. 14 is a diagram illustrating an exemplary configuration of a hardware circuit 55 that is dedicated according to the first to fifth embodiments.

The hardware circuit 55 that is dedicated includes the input unit 51, the output unit 54, and a processing circuitry 56. The processing circuitry 56 is a single circuit, a complex circuit, a programmed processor, a parallel-programmed processor, an application specific integrated circuit (ASIC), a field programmable gate array (FPGA), or a circuit obtained by combining these. The functions of the controller 13 may be implemented individually or collectively by the processing circuitry 56. Note that the controller 13 may be implemented by a combination of the control circuit 50 and the hardware circuit 55.

In a case where the learning device 25 is a device external to the controller 13, the learning device 25 is implemented by processing circuitry similarly to the controller 13. The processing circuitry that implements the learning device 25 is the control circuit 50 illustrated in FIG. 13 or the hardware circuit 55 that is dedicated illustrated in FIG. 14.

In a case where the life estimation device 24 is a device external to the controller 13, the life estimation device 24 is implemented by processing circuitry similarly to the controller 13. The processing circuitry that implements the life estimation device 24 is the control circuit 50 illustrated in FIG. 13 or the hardware circuit 55 that is dedicated illustrated in FIG. 14.

Specific modes of distribution or integration of the components in the transfer systems 1A to 1E according to the first to fifth embodiments are not limited to those described in the first to fifth embodiments. All or some of the components of the transfer systems 1A to 1E may be functionally or physically distributed or integrated in units of any size.

The configurations illustrated in the above embodiments each illustrate an example of the content of the present disclosure. The configurations of the embodiments can be combined with another known technique.

The configurations of the embodiments may be combined together as appropriate. A part of the configurations of the embodiments can be omitted or modified without departing from the scope of the present disclosure.

### REFERENCE SIGNS LIST

1A, 1B, 1C, 1D, 1E transfer system; 10 transfer

path; 11, 11a, 11b, 11c, 11d, 11e, 11f Carrier; 12, 12a, 12b, 12c, 12d, 12e, 12f, 12g, 12h, 12l, 12j, 12k, 12l, 12m, 12n transfer path unit; 13 controller; 14 data communication line; 15 reference point; 16 arrow; 17 permanent magnet; 18 guide rail; 19 position detection unit; 21 input device; 22 reading device; 23, 53 memory; 24 life estimation device; 25 learning device; 26 individual identifier; 31 preprocessing unit; 32, 41 data acquisition unit; 33 model generation unit; 34 trained model storage unit; 35 learning data; 36 trained model; 42 inference unit; 43 inference data; 44 remaining life data; 50 control circuit; 51 input unit; 52 processor; 54 output unit; 55 hardware circuit; 56 processing circuitry.

1. A transfer system comprising:
a plurality of transferring bodies;
a transfer path on which the plurality of the transferring bodies moves; and
a controller to assign identification information to each of the plurality of the transferring bodies to manage the plurality of the transferring bodies, and control each of the plurality of the transferring bodies, wherein
on the transfer path, a reference point is set as a reference of position in a forward direction that is one direction in which each of the plurality of the transferring bodies is moved,
the controller assigns, to a first transferring body that is one of the plurality of the transferring bodies and is closest to the reference point in the forward direction, first identification information as a baseline of the identification information and assigns, to each second transferring body that is the transferring body other than the first transferring body among the plurality of the transferring bodies, second identification information that is the identification information in sequence from the first identification information in an order of arrangement of the second transferring body in the forward direction or a backward direction opposite to the forward direction,
each of the plurality of the transferring bodies is provided with an individual identifier unique for each of the plurality of the transferring bodies, and
the controller holds the identification information assigned to each of the plurality of the transferring bodies in association with the individual identifier and, at startup of the transfer system, assigns the identification information associated with the individual identifier of the first transferring body to the first transferring body as the first identification information.

2. The transfer system according to claim 1, comprising
position detection circuitry to detect a position of each of the plurality of the transferring bodies on the transfer path, wherein
the controller specifies the first transferring body on the basis of a result of detection by the position detection circuitry.

3. The transfer system according to claim 1, wherein the transfer path is a closed path with no branch.

4. The transfer system according to claim 1, wherein
each of the plurality of the transferring bodies is provided with a permanent magnet, and
the transfer path includes a coil to generate thrust that moves the transferring bodies by interaction with a magnetic field generated by the permanent magnet.

5.-7. (canceled)

8. The transfer system according to claim 1, comprising
a reader to read the individual identifier provided to the first transferring body, wherein
the controller acquires the individual identifier read by the reader.

9. The transfer system according to claim 8, wherein the reference point is set in accordance with a position of the reader.

10. The transfer system according to claim 8, wherein the individual identifier is provided on each of two or more surfaces of the transferring body.

11. A transfer system comprising:
a plurality of transferring bodies;
a transfer path on which the plurality of the transferring bodies moves; and
a controller to assign identification information to each of the plurality of the transferring bodies to manage the plurality of the transferring bodies, and control each of the plurality of the transferring bodies, wherein
on the transfer path, a reference point is set as a reference of position in a forward direction that is one direction in which each of the plurality of the transferring bodies is moved,
the controller assigns, to a first transferring body that is one of the plurality of the transferring bodies and is closest to the reference point in the forward direction, first identification information as a baseline of the identification information and assigns, to each second transferring body that is the transferring body other than the first transferring body among the plurality of the transferring bodies, second identification information that is the identification information in sequence from the first identification information in an order of arrangement of the second transferring body in the forward direction or a backward direction opposite to the forward direction,
the controller periodically stores, in a memory, position information that indicates a position of each of the plurality of the transferring bodies on the transfer path in association with the identification information assigned to each of the plurality of the transferring bodies, and
at startup of the transfer system, the controller compares startup position information that indicates a position of each of the plurality of the transferring bodies at the startup with latest position information that is the position information stored in the memory and is a latest piece of the position information before the startup to specify the transferring body of which the position indicated by the latest position information is the closest along the transfer path from the position indicated by the startup position information for each of the plurality of the transferring bodies, and assigns the identification information associated with the latest position information of the transferring body specified to each of the plurality of the transferring bodies.

12. A transfer system comprising:
a plurality of transferring bodies;
a transfer path on which the plurality of the transferring bodies moves; and
a controller to assign identification information to each of the plurality of the transferring bodies to manage the plurality of the transferring bodies, and control each of the plurality of the transferring bodies, wherein
on the transfer path, a reference point is set as a reference of position in a forward direction that is one direction in which each of the plurality of the transferring bodies is moved,
the controller assigns, to a first transferring body that is one of the plurality of the transferring bodies and is closest to the reference point in the forward direction, first identification information as a baseline of the identification information and assigns, to each second transferring body that is the transferring body other than the first transferring body among the plurality of the transferring bodies, second identification information that is the identification information in sequence from the first identification information in an order of arrangement of the second transferring body in the forward direction or a backward direction opposite to the forward direction,
the transfer system comprises life estimation circuitry to estimate, for each of the plurality of the transferring bodies, a remaining life that is a period until maintenance of the transferring body is performed, and
the controller exchanges the identification information assigned to each of the plurality of the transferring bodies on the basis of a result of estimation of the remaining life for each of the plurality of the transferring bodies.

13. The transfer system according to claim 12, wherein the controller exchanges, on the basis of the result of estimation of the remaining life for each of the plurality of the transferring bodies, between the identification information assigned to the transferring body having the remaining life estimated to be the longest among the plurality of the transferring bodies and the identification information assigned to the transferring body having the remaining life estimated to be the shortest among the plurality of the transferring bodies.

14. The transfer system according to claim 12, comprising learning circuitry including:
data acquisition circuitry to acquire learning data including operation state data that is data indicating a mode of movement of the transferring body, operation history data that is data indicating a history of operation of the transferring body, and remaining life data indicating the remaining life obtained on the basis of an actual life of the transferring body; and
model generation circuitry to generate, on the basis of the learning data, a trained model that is to be used to infer the remaining life from the operation state data and the operation history data.

15. The transfer system according to claim 12, wherein
the life estimation circuitry includes:
data acquisition circuitry to acquire, for each of the plurality of the transferring bodies, operation state data that is data indicating a mode of movement of the transferring body, and operation history data that is data indicating a history of operation of the transferring body; and
inference circuitry to infer the remaining life of each of the plurality of the transferring bodies by inputting the operation state data and the operation history data to a trained model that is to be used to infer the remaining life from the operation state data and the operation history data.
